(19) United States
(12) Patent Application Publication
(10) Pub. No.: US 2010/0149681 A1
(43) Pub. Date: Jun. 17, 2010

(54) RECORDING METHOD AND STORAGE DEVICE

(75) Inventor: Hidekazu Masuyama, Kanagawa (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/636,562

(22) Filed: Dec. 11, 2009

(30) Foreign Application Priority Data
Dec. 12, 2008 (JP) 2008-317537

(51) Int. Cl. G11B 21/02

(52) U.S. Cl. 360/75; G9B/21.003

(57) ABSTRACT

According to one embodiment, a recording method includes: skipping a track by a skip amount in a skip region smaller than an overall recording region on a magnetic recording medium by using an extra region that is unnecessary for securing a storage capacity to be provided by a storage device, the extra region being on the recording surface of the magnetic recording medium; and recording data while skipping the track in the skip region, wherein the skip region is set to a region in which a track to be recorded on the magnetic recording medium is expected to influence an adjacent track in accordance with at least one of a condition and a state of the storage device.

### CROSS-REFERENCE TO RELATED APPLICATIONS

This application is based upon and claims the benefit of priority from Japanese Patent Application No. 2008-317537, filed Dec. 12, 2008, the entire contents of which are incorporated herein by reference.

### BACKGROUND

1. Field

One embodiment of the invention relates to a recording method and a storage device, and particularly to a recording method and a storage device suitable for a magnetic recording medium.

2. Description of the Related Art

In recent years, in accordance with development of technology, data amount processed by an information processing system has been increasing, and a data storage device is desired to have a larger capacity. Accordingly, a storage device realizes high recording density by increasing track per inch (TPI) or bit per inch (BPI). With the high TPI, however, if data is repeatedly recorded (written) on a track for several ten thousands times or several hundred thousands times, an adjacent track is influenced by magnetic flux leakage from a recording head, instability of on-track accuracy, and the like, and therefore, data destruction (side erasure) is occasionally caused in the adjacent track.

In order to avoid the side erasure, a hardware that suppresses the magnetic flux leakage from the recording head or enhances an on-track accuracy may be considered. However, such hardware is technically difficult to realize. On the other hand, a firmware that reads out data in an adjacent track after data is recorded on a track, confirms whether the data is influenced by the recording to the track, and performs the data recording again if the influence is detected, may be considered. However, such firmware needs complicated recovery operation sequences, thereby degrades the performance of the storage device.

In a conventional magnetic disk format, sectors are assigned to successive tracks in the order from a logical cylinder (or a logical track) having a high transfer rate in an outer region towards an inner direction, until a storage capacity to be provided by a storage device is fulfilled. When the sector assignment is completed, extra tracks in the inner region are set as unused tracks.

In order to prevent an adjacent track from being influenced by a target track to be recorded when the sectors are assigned to successive tracks, there is known a technology that assigns sectors while skipping some tracks (for example, Japanese Patent Application Publication (KOKAI) No. H11-296979). By performing the skip processing to the entire recording surface of the magnetic disk, the influence of the adjacent track to the target track can be suppressed. However, for example, when the skip processing is performed and record data in every other track, the storage capacity of the storage device becomes half of the case when the skip processing is not performed. As a result, the recording density is decreased. Therefore, such conventional skip processing is not practical.

In the conventional storage device, it is difficult to perform high density recording with high reliability.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are exemplary diagrams of tracks to be used and tracks not to be used when a magnetic recording medium is a magnetic disk according to an embodiment of the invention;

FIGS. 2A and 2B are exemplary diagrams illustrating track skipping in the embodiment;

FIG. 3 is an exemplary plane view of a storage device in the embodiment;

FIGS. 4A and 4B are exemplary diagrams illustrating skip processing in an outer region of a magnetic disk in the embodiment;

FIGS. 5A and 5B are exemplary diagrams illustrating format by the skip processing in the outer region of the magnetic disk in the embodiment;

FIG. 6 is an exemplary diagram illustrating the skip processing in the outer region and an inner region of the magnetic disk in the embodiment;

FIGS. 7A and 7B are exemplary diagrams illustrating format by skip processing in the outer region and the inner region of the magnetic disk in the embodiment;

FIGS. 8A and 8B are exemplary diagrams illustrating skip processing when a specific head is used in the embodiment;

FIGS. 9A and 9B are exemplary diagrams illustrating format by skip processing when the specific head is used in the embodiment;

FIG. 10 is an exemplary diagram illustrating skip processing with combination of a first case and a third case in the embodiment;

FIG. 11 is an exemplary diagram illustrating skip processing when a skip amount is set to two tracks in the embodiment;

FIG. 12 is an exemplary diagram illustrating skip processing when a track pitch width is expanded in the embodiment;

FIG. 13 is an exemplary diagram illustrating skip processing when the pitch width of the track to be skipped is narrowed in the embodiment;

FIG. 14 is an exemplary block diagram of a storage device in the embodiment;

FIG. 15 is an exemplary flowchart of skip setting processing when the track pitch is fixed in the embodiment;

FIG. 16 is an exemplary skip track table of the first case in the embodiment;

FIG. 17 is an exemplary skip track table of a second case in the embodiment;

FIG. 18 is an exemplary skip track table when a third case is applied to a specific region on the magnetic disk in the embodiment;

FIG. 19 is an exemplary skip track table when the third case is applied to the entire region on the magnetic disk in the embodiment;

FIG. 20 is an exemplary skip track table of a fourth case in the embodiment;

FIG. 21 is an exemplary skip track table of a fifth case in the embodiment;

FIG. 22 is an exemplary flowchart of skip setting processing of when the track pitch is variable in the embodiment;

FIG. 23 is an exemplary skip track table of the first case in the embodiment;

FIG. 24 is an exemplary skip track table of the second case in the embodiment;

FIG. 25 is an exemplary skip track table when the third case is applied to a specific region on the magnetic disk in the embodiment;

FIG. 26 is an exemplary skip track table when the third case is applied to the entire region on the magnetic disk in the embodiment; and

FIG. 27 is an exemplary skip track table of the fourth case in the embodiment.

### DETAILED DESCRIPTION

Various embodiments according to the invention will be described hereinafter with reference to the accompanying drawings. In general, according to one embodiment of the invention, a recording method includes: skipping a track by a skip amount in a skip region smaller than an overall recording region on a magnetic recording medium by using an extra region that is unnecessary for securing a storage capacity to be provided by a storage device, the extra region being on the recording surface of the magnetic recording medium; and recording data while skipping the track in the skip region, wherein the skip region is set to a region in which a track to be recorded on the magnetic recording medium is expected to influence an adjacent track in accordance with at least one of a condition and a state of the storage device.

According to another embodiment of the invention, a storage device includes: a head configured to record data in a recording surface of a magnetic recording medium; a driving module configured to control a position of the head on the magnetic recording medium; a storage module configured to store therein information for specifying skip processing; and a controller configured control the driving module to skip, based on the information stored in the storage module, a track by a skip amount in a skip region smaller than an overall recording region on the magnetic recording medium by using an extra region that is unnecessary for securing a storage capacity to be provided by the storage device, and control the head to record the data while skipping the track in the skip region, the extra region being on the recording surface of the magnetic recording medium, wherein the skip region is set to a region in which a track to be recorded on the magnetic recording medium is expected to influence an adjacent track in accordance with at least one of a condition and a state of the storage device.

In a recording method and a storage device, when data is recorded on a magnetic recording medium with an arbitrary track pitch, the data is recorded while skipping some tracks in an arbitrary region (or area) smaller than the overall recording region of the magnetic recording medium. The arbitrary region utilizes an extra region that is unnecessary for securing the storage capacity to be provided by the storage device. The extra region is on the recording surface of the magnetic recording medium. The track pitch may be fixed or varied at least in the arbitrary region of the magnetic recording medium. An amount of tracks to be skipped is set to, for example, a natural number multiple of the track width.

By providing a region in which some tracks are skipped on only a portion of the recording surface, it is possible to suppress influence of a track to be recorded onto an adjacent track, so as to be able to perform high density recording with high reliability.

A recording method and a storage device according to various embodiments of the invention will be described hereinafter with reference to the accompanying drawings.

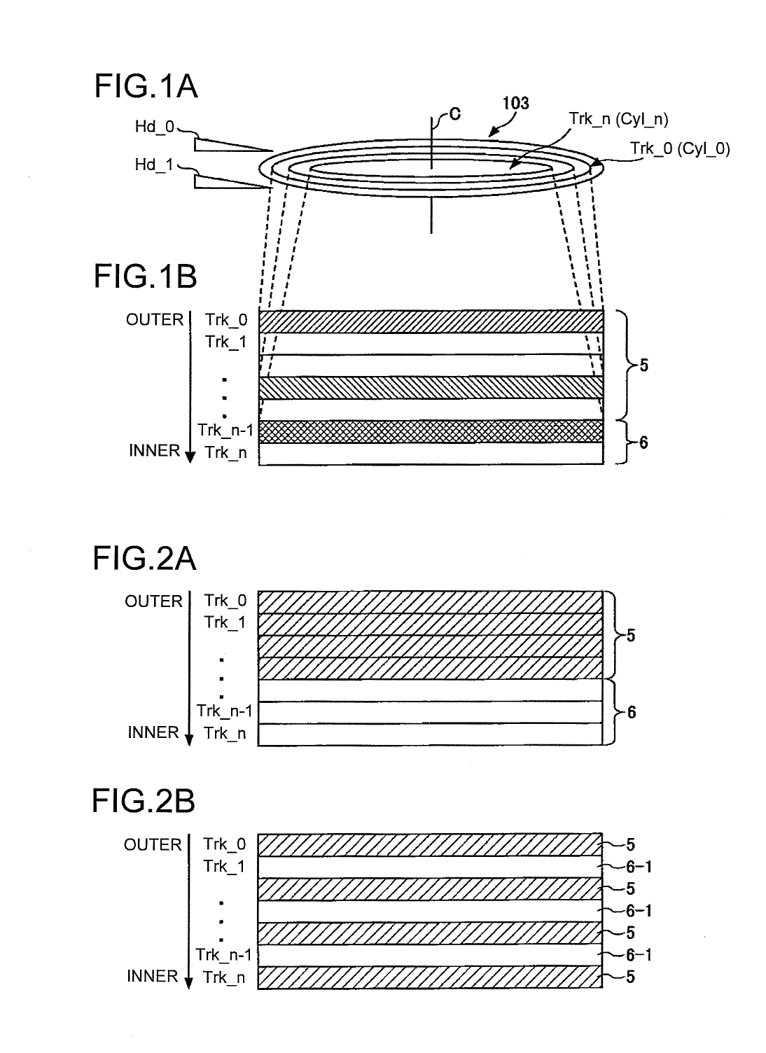

FIGS. 1A and 1B are diagrams for explaining tracks to be used and tracks not to be used, when a magnetic recording medium is a magnetic disk. FIG. 1A is a diagram illustrating a plurality of tracks Trk_0 to Trk_n (or cylinders Cyl_0 to Cyl_n) that are formed on an upper recording surface of a magnetic disk 103 and in which data is recorded by a head Hd_0. Reference character C indicates a center of the magnetic disk 103. The tracks Trk_0 to Trk_n are concentrically formed in a region (or a zone) having an arbitrary radius on the upper recording surface of the magnetic disk 103. The region having the arbitrary radius (the arbitrary region or area) corresponds to a portion of the entire upper recording surface of the magnetic disk 103 and is smaller than the entire upper recording surface. It is needless to say that the similar tracks may be formed on a lower recording surface of the magnetic disk 103, and data may be recorded therein by another head Hd_1. In addition, if two or more magnetic disks 103 are provided, one or more heads corresponding to each magnetic disk 103 are provided.

FIG. 1B is a diagram illustrating the tracks Trk_0 to Trk_n on the magnetic disk 103. In FIG. 1B, a downward direction indicates an inner direction of the magnetic disk 103 and a horizontal direction indicates a track direction (or a circumferential direction). In FIG. 1B, reference numeral 5 indicates a track to be used and reference numeral 6 indicates a track not to be used. The track 5 is a track to be used for achieving a storage capacity to be provided by the storage device (or the magnetic disk device in the embodiment), and the track 6 is a track not to be used (or extra track) for achieving a storage capacity to be provided by the storage device.

FIGS. 2A and 2B are diagrams for explaining skip processing of tracks. In FIGS. 2A and 2B, the same portions as those of FIG. 1B are indicated by the same reference numerals and the explanation thereof is omitted. FIG. 2A is a diagram of when the tracks are not skipped. Here, the hatched tracks are the tracks 5. On the other hand, FIG. 2B is a diagram of when the tracks are skipped for suppressing influence of the track to be recorded against the adjacent track. Here, the hatched tracks are the used tracks 5. In addition, reference numeral 6-1 indicates an unused track that is skipped. In the embodiment, the amount of tracks to be skipped is fixed to one track, but the skip amount is not limited to one track. The skip amount may be a natural number multiple of track or may be variable.

In this way, a region in which some tracks are skipped is provided in a portion of the recording surface, by effectively using the extra region on the recording surface of the magnetic recording medium. Accordingly, it becomes possible to suppress the influence of the track to be recorded onto the adjacent track, and becomes possible to perform high density recording with high reliability. Note that the region in which some tracks are skipped and the skip amount may be set according to at least one of a condition and a state of the storage device, so that the influence of the track to be recorded onto the adjacent track is effectively suppressed.

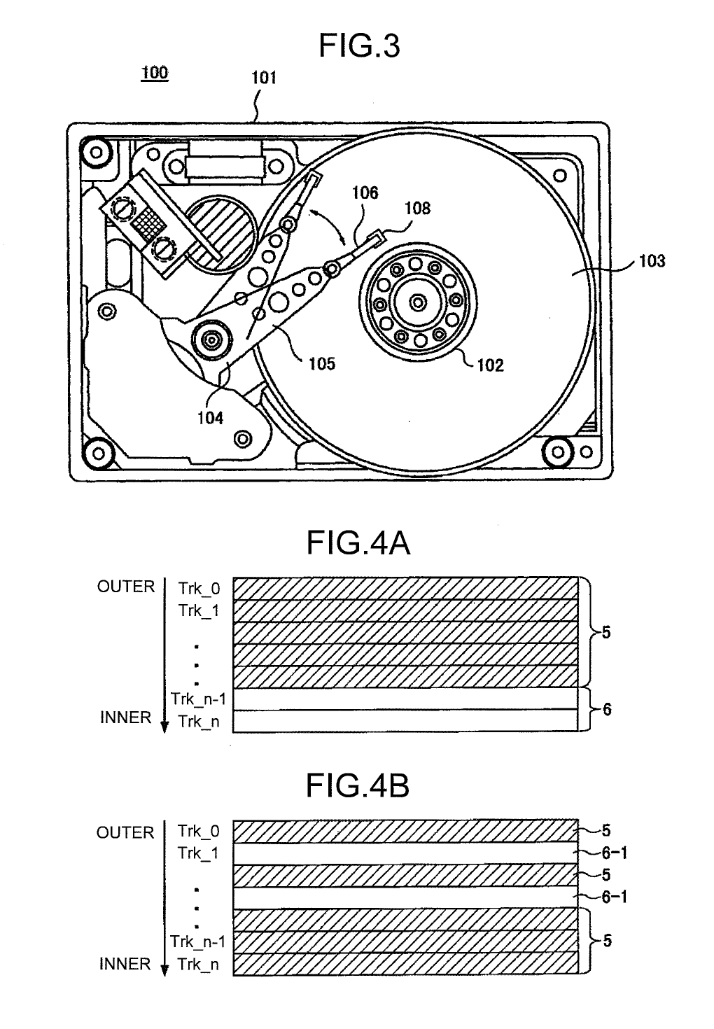

FIG. 3 is a plane view of a storage device of the embodiment. In FIG. 3, a magnetic storage device 100 includes an approximate housing 101. In the housing 101, a hub 102 driven by a spindle motor (not shown), the magnetic disk 103 fixed and rotated by the hub 102, an actuator 104, an arm 105 and a suspension 106 that are supported by the actuator 104 and driven in the radial direction of the magnetic disk 103, and a slider 108 supported by the suspension 106, are provided. The actuator 104 configures a driver (or a drive module) that controls a position of the head on the magnetic disk 103.

The recording system used for recording data in the magnetic disk 103 may be a horizontal magnetic recording system or a vertical magnetic recording system. In addition, the magnetic recording system may be a heat assisted magnetic recording system that performs magnetic recording to a magnetic recording medium having high coercive force resistant to thermal fluctuation. In the case of the heat assisted magnetic recording system, the magnetic recording is performed in the state of decreasing the coercive force in a part of the magnetic recording medium on which a hot spot is formed, by irradiating an optical spot to increase the temperature.

The minimum magnetic recording unit size in the magnetic storage device 100 is specified by a cylinder (or a track), a head, and a sector on the magnetic disk 103.

The slider 108 comprises a head integrally having a write element and a read element. The slider 108 scans a track on the magnetic disk 103 in the state where a floating surface floats at a predetermined amount from the surface of the magnetic disk 103. When the heat assisted magnetic recording system is used, the head integrally provided on the slider 108 has a light source that provides propagation light to an optical waveguide module.

Note that the basic structure of the magnetic storage device is not limited to the structure illustrated in FIG. 3. The number of the magnetic disk 103 and the number of the slider 108 may be equal to or more than one. For example, when the magnetic recording and reproducing is performed to both surfaces of the magnetic disk 103, two sliders 108 are provided with respect to one magnetic disk 103.

Next, following various cases are explained. In a first case, a region having a track to be skipped (skip region) is provided in an outer region of the magnetic disk 103; in a second case, the skip region is provided in the outer region and an inner region of the magnetic disk 103; in a third case, the skip region is provided with respect to a specific head; in a fourth case, the skip region is provided with any combination of the first to the third cases; and in a fifth case, the skip region is provided with variable skip amount.

The first case is explained. Any upper devices (or host devices) of the magnetic storage device 100 use a logical block address of the magnetic disk 103 as a storage destination of system information of the upper device, in increasing order. With an increase in a number of recordings of data with respect to the magnetic disk 103, the possibility of data destruction in an adjacent track due to influence by a track to be recorded increases. Therefore, in a region having a young logical block address, that is, in the outer region of the magnetic disk 103 in the magnetic storage device 100, the skip processing that skips some tracks (cylinders) is applied when a storage capacity to be provided by the magnetic storage device 100 can be secured. The skip amount and the range are dynamically changed by the storage capacity to be provided by the magnetic storage device 100 when the magnetic storage device 100 executes a format unit command from the upper device. The same applies to the second to the fifth cases explained later.

FIGS. 4A and 4B are diagrams for explaining the skip processing in the outer region. In FIGS. 4A and 4B, the same portions as those in FIGS. 2A and 2B are indicated by the same reference numerals and the explanation thereof is omitted. FIG. 4A is a diagram of when the skip processing of the tracks is not performed, and FIG. 4B is a diagram of when the skip processing of the tracks is performed. In this case, among the tracks Trk_0 to Trk_n, the skip amount of the tracks in the outer region of the magnetic disk 103 is, for example, one track.

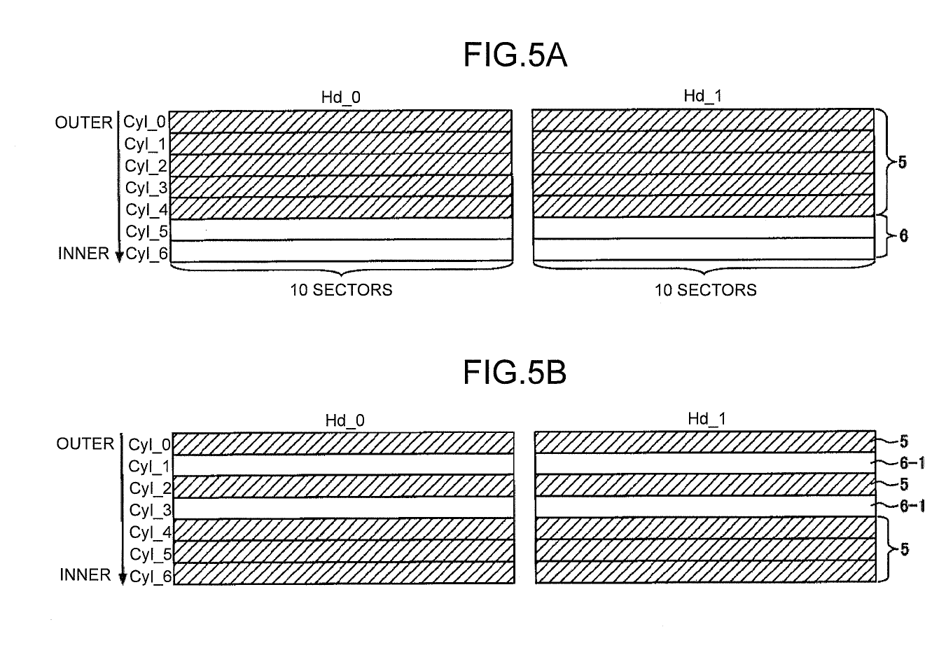

One example of the formatting by the skip processing in this case comprises the following steps (or procedures) ST1 to ST3. FIGS. 5A and 5B are diagrams for explaining the format by the skip processing in the outer region. In FIGS. 5A and 5B, the same portions as those in FIGS. 4A and 4B are indicated by the same reference numerals and the explanation thereof is omitted. In FIGS. 5A and 5B, instead of the tracks, cylinders Cyl_0 to Cyl_6 are illustrated by taking into account the case when the magnetic disk 103 is provided in the magnetic storage device 100.

In ST1, the storage capacity to be formatted when the format unit command is executed, that is, the storage capacity to be provided by the magnetic storage device 100, is compared with the storage capacity capable of being provided by the magnetic storage device 100 as a whole, to obtain a difference therebetween. In the embodiment, the storage capacity to be provided by the magnetic storage device 100 is 100 sectors (=2 heads×5 tracks×10 sectors), and the storage capacity capable of being provided by the entire magnetic storage device 100 is 140 sectors (=2 heads×7 tracks×10 sectors). Accordingly, the difference is 40 sectors (=4 tracks).

In ST2, when the skip processing is not performed as illustrated in FIG. 5A, the format process is performed to, for example, Cyl_0/Hd_0, Cyl_0/Hd_1, Cyl_1/Hd_0, Cyl_1/Hd_1, . . . , in this order. On the other hand, when the skip processing is performed as illustrated in FIG. 5B, because the cylinder (track) skip processing is applied in the outer region, the format process is performed to Cyl_0/Hd_0, Cyl_0/Hd_1, Cyl_2/Hd_0, Cyl_2/Hd_1, in this order, without using the cylinder Cyl_1. Note that, for example, Cyl_0/Hd_0 means that the head Hd_0 records data in the cylinder Cyl_0, and Cyl_0/Hd_1 means that the head Hd_1 records data in the cylinder Cyl_0.

In ST3, the process is performed to Cyl_4/Hd_0 and Cyl_4/Hd_1, in this order, without using the cylinder Cyl_3. However, in the embodiment, the extra unused regions in the magnetic disk 103 are all used up already at this time. Accordingly, the skip processing is not performed hereinafter, and the format process is performed to the successive tracks in the order of Cyl_5/Hd_0, Cyl_5/Hd_1, Cyl_6/Hd_0, Cyl_6/Hd_1, . . . .

The aforementioned skip processing is not limited to be performed on the outer region. If it is known by access log information and the like in the magnetic storage device 100 that the data is recorded many times in the upper device, the skip processing may be applied a specific zone such as a center region or an inner region.

The second case is explained. The slider 108 of the magnetic storage device 100 is mounted so that the head orientation becomes parallel to the orbit of the track in the center region in the radius direction of the magnetic disk 103 (namely, so that a yaw angle becomes near zero). Accordingly, in the outer region or the inner region on the magnetic disk 103, a certain degree (a predetermined amount larger than zero) of the angle (yaw angle) is made between the head and the track. The yaw angle may cause data destruction in the adjacent track by the influence of the track to be recorded. Consequently, in the outer region and the inner region of the magnetic disk 103, cylinder (track) skip processing is applied when the storage capacity to be provided by the magnetic storage device 100 can be secured.

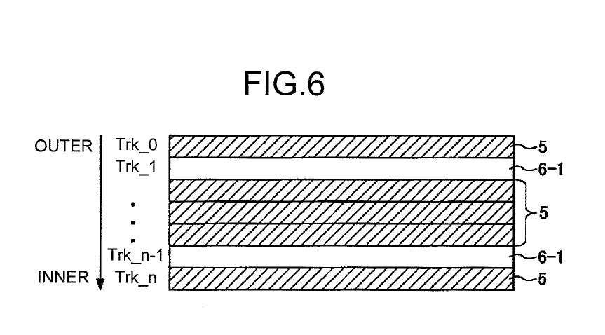

FIG. 6 is a diagram for explaining the skip processing in the outer region and the inner region. In FIG. 6, the same portions as those in FIGS. 4A and 4B are indicated by the same reference numerals and the explanation thereof is omitted. When the skip processing of the tracks is not performed, the explanation is the same as that in FIG. 4A, therefore the illustration thereof is omitted. FIG. 6 is a diagram of when the skip processing of the tracks is performed. In this case, among the tracks Trk_0 to Trk_n, the skip amount of the tracks in the outer region and the inner region of the magnetic disk 103 is, for example, one track.

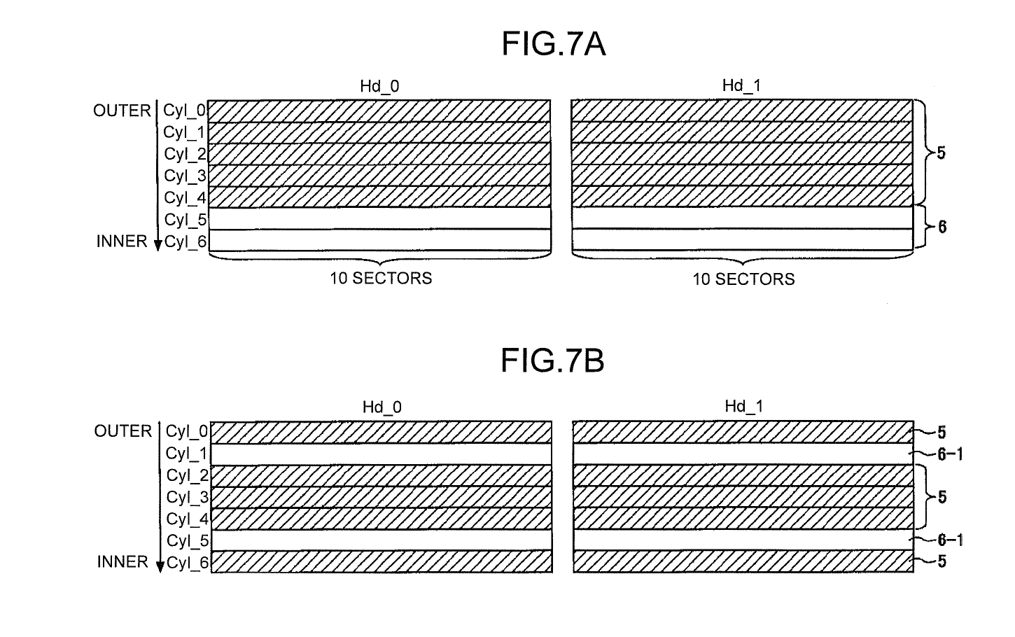

One example of the formatting by the skip processing in this case comprises the following steps (or procedures) ST11 to ST14. FIGS. 7A and 7B are diagrams for explaining the formatting by the skip processing in the outer region and the inner region. In FIGS. 7A and 7B, the same portions as those in FIGS. 5A and 5B are indicated by the same reference numerals and the explanation thereof is omitted.

In ST11, the storage capacity formatted when the format unit command is executed, that is, the storage capacity to be provided by the magnetic storage device 100 is compared with the storage capacity capable of being provided by the entire magnetic storage device 100, to obtain the difference therebetween. In the embodiment, the difference is 40 sectors (=4 tracks).

In ST12, when the skip processing is not performed as illustrated in FIG. 7A, the format process is performed to, for example, Cyl_0/Hd_0, Cyl_0/Hd_1, Cyl_1/Hd_0, Cyl_1/Hd_1, . . . , in this order. On the other hand, when the skip processing is performed as illustrated in FIG. 7B, because the cylinder (track) skip processing is applied in the outer region and the inner region, the format process is performed to Cyl_0/Hd_0, Cyl_0/Hd_1, Cyl_2/Hd_0, Cyl_2/Hd_1, in this order, without using the cylinder Cyl_1.

In ST13, the process is performed until Cyl_2/Hd_1. However, all of the extra unused regions are to be used up if the skip processing is performed with the same skip amount in the outer region and the inner region. Therefore, the format process is performed hereinafter to the successive tracks Cyl_3/Hd_0, Cyl_3/Hd_1, Cyl_4/Hd_0, Cyl_4/Hd_1, in this order.

In ST14, in order to consider the skip processing in the inner region, because the cylinder Cyl_5 should be a target of the skip processing, the format process is performed to Cyl_6/Hd_0 and Cyl_6/Hd_1, in this order, without using the cylinder Cyl_5.

Note that the skip processing is not limited to be performed for one of the outer region, the inner region, and the combination thereof, and the skip processing may be performed in the center region. In other words, if unstable on-track accuracy of the head caused depending on compatibility with the magnetic disk 103 possibly leads to data destruction in the adjacent track due to the influence of the track to be recorded, for example, the skip processing may be applied to the center region or the specific zone on the magnetic disk 103.

The third case is explained. When the head width of the magnetic storage device 100 is larger than the designed value of the head due to manufacturing fluctuation, regardless of the yaw angle, data destruction in the adjacent track is caused by the influence of the track to be recorded. Thus, if it is previously known that the head width of the specific head is larger than the designed value by the test before shipment of the magnetic storage device 100, the track skip processing is applied to only the recording surfaces (tracks) of the magnetic disk 103 that are scanned by the specific head. Here, the track skip processing is applied when the storage capacity to be provided by the magnetic storage device 100 can be secured.

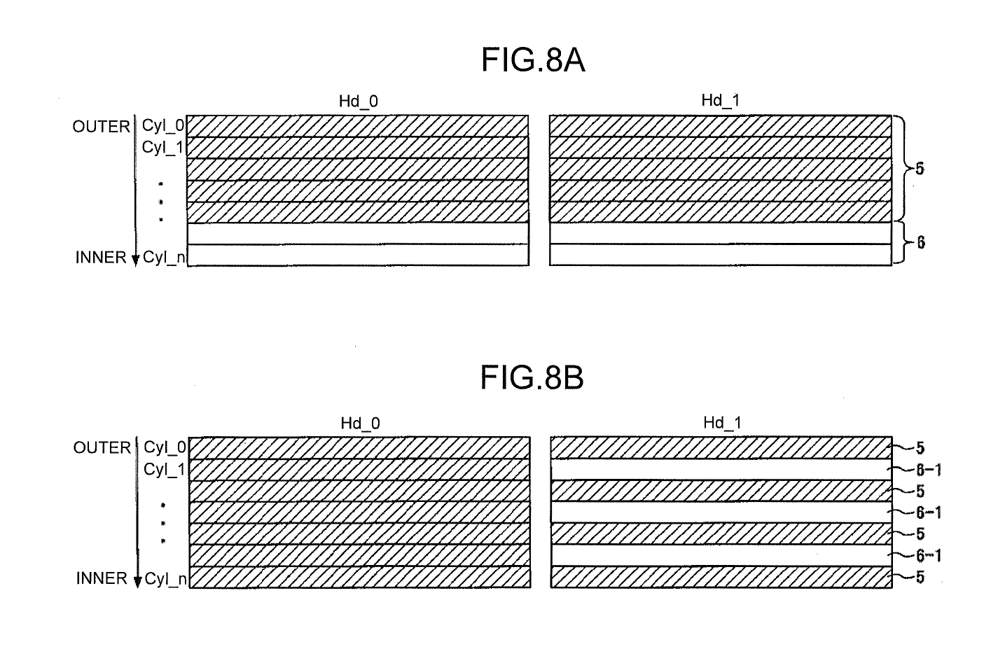

FIGS. 8A and 8B are diagrams for explaining the skip processing when the specific head is used. In FIGS. 8A and 8B, the same portions as those in FIGS. 7A and 7B are indicated by the same reference numerals and the explanation thereof is omitted. FIG. 8A is a diagram of when the track skip processing is not performed, and FIG. 8B is a diagram of when the track skip processing is performed. The head width of the head Hd_0 is equivalent to the designed value. The head width of the specific head Hd_1 is larger than the designed value, and the skip amount thereof is, for example, one track.

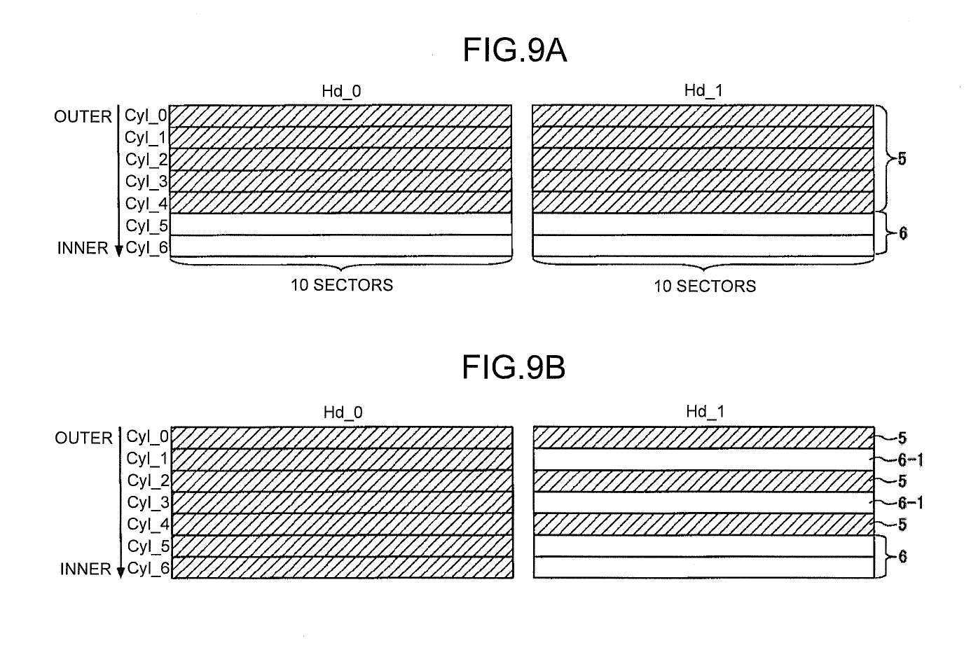

One example of the formatting by the skip processing in this case comprises the following skips (or procedures) ST21 and ST22. FIGS. 9A and 9B are diagrams for explaining the formatting by the skip processing only when the specific head is used. In FIGS. 9A and 9B, the same portions as those in FIGS. 8A and 8B are indicated by the same reference numerals and the explanation thereof is omitted.

In ST21, the storage capacity formatted when the format unit command is executed, that is, the storage capacity to be provided by the magnetic storage device 100 is compared with the storage capacity capable of being provided by the entire magnetic storage device 100, to obtain the difference therebetween. In the embodiment, the difference is 40 sectors (=4 tracks).

In ST22, when the skip processing is not performed as illustrated in FIG. 9A, the format process is performed to, for example, Cyl_0/Hd_0, Cyl_0/Hd_1, Cyl_1/Hd_0, Cyl_1/Hd_1, . . . , in this order. On the other hand, when the skip processing is performed as illustrated in FIG. 9B, and for example, when the head width of the head Hd_1 is larger than the designed value, because the track skip processing is applied to only the head Hd_1, the process is performed to Cyl_0/Hd_0, Cyl_0/Hd_1, Cyl_1/Hd_0, Cyl_2/Hd_0, Cyl_2/Hd_1, in this order.

Note that the skip processing is not limited to be performed to the specific head having the head width larger than a designed value. The skip processing may be applied to a head in which the data in an adjacent track is possibly destructed by the influence of a track to be recorded, such as a head whose magnetization characteristics are stronger than those of the other heads, a head whose leakage magnetic flux is greater than that of the other heads, and a head whose on-track accuracy is instable depending on compatibility with the magnetic disk 103. As the information specifying a head to which the skip processing is required to be applied, log information obtained during actual operation after shipment of the magnetic storage device 100 may be used in addition to the measurement information (or test result information) obtained from a test before shipment.

In the skip processing when the specific head is used, the storage capacity is considerably decreased if the skip processing is performed to the entire recording surface of the corresponding magnetic disk 103. Accordingly, the skip processing is desirably performed to only a region with high possibility of the data destruction caused in an adjacent track due to influence of a track to be recorded.

The forth case considering any combination of the first case to the third case is explained. Although examples of conditions and states of the magnetic storage device 100 are explained in the first case to the third case, the magnetic storage device may not have enough storage capacity to skip all tracks and cylinders for satisfying desired condition. Consequently, the skip processing with any combination of the first case to the third case may be performed.

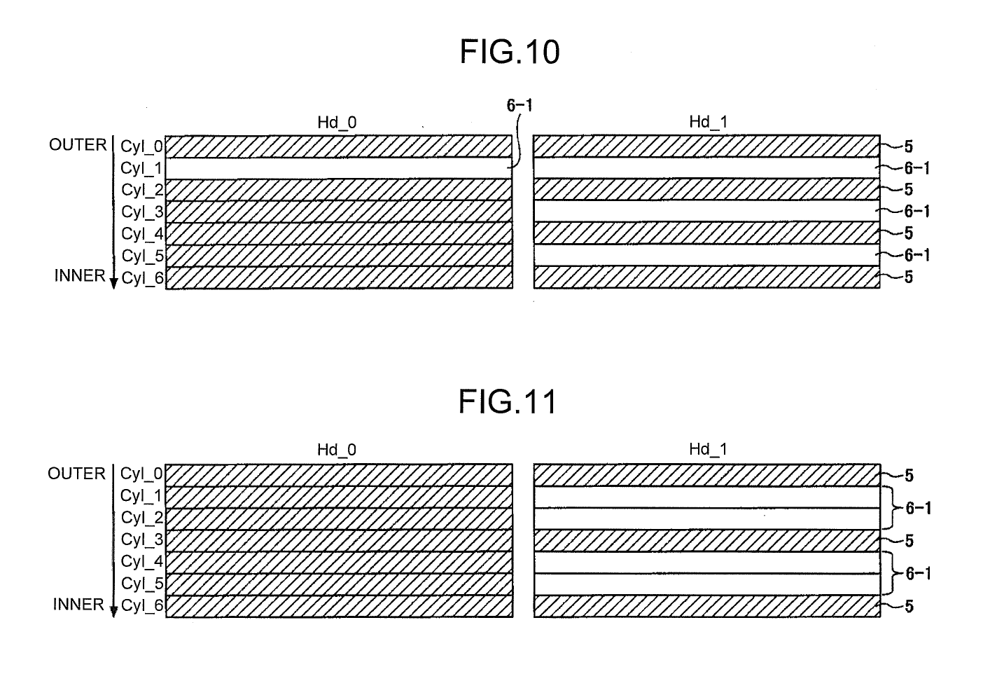

One example of the formatting by the skip processing in this case comprises the following step (or procedure) ST31. FIG. 10 is a diagram for explaining the skip processing with a combination of the first case and the third case. In FIG. 10, the same portions as those in FIG. 9B are indicated by the same reference numerals and the explanation thereof is omitted.

In ST31, the outer region of the magnetic disk 103, for example, is protected as in the formatting in the first case, in addition to the format in the third case. In this case, the cylinder 6 of the head Hd_1 that is not used in the format in the third case is used. That is to say, the Cyl_6/Hd_1 of Cyl_5/Hd_1 and Cyl_6/Hd_1 is used. As a result, the track skip processing is performed to the used cylinder 5 of the head Hd_0, that is, Cyl_1/Hd_0, thereby satisfying the first and the third cases.

The fifth case is explained. The skip amount may be set to two or more tracks (cylinders) depending on the characteristics or state of the head.

One example of the formatting by skip processing with the skip amount of two tracks (cylinders) comprises the following step (or procedure) ST41. FIG. 11 is a diagram for explaining the skip processing with the skip amount of two tracks. In FIG. 11, the same portions as those in FIG. 9B are indicated by the same reference numerals and the explanation thereof is omitted.

In ST41, if it is previously known that the head width of the head Hd_1 is significantly larger than the designed value, the skip amount of the head Hd_1 having performed the formatting of the third case is set to two tracks.

Besides, instead of setting the skip amount to two or more tracks (cylinders), the track pitch width of the track to be skipped may be expanded in comparison with the other tracks not to be skipped.

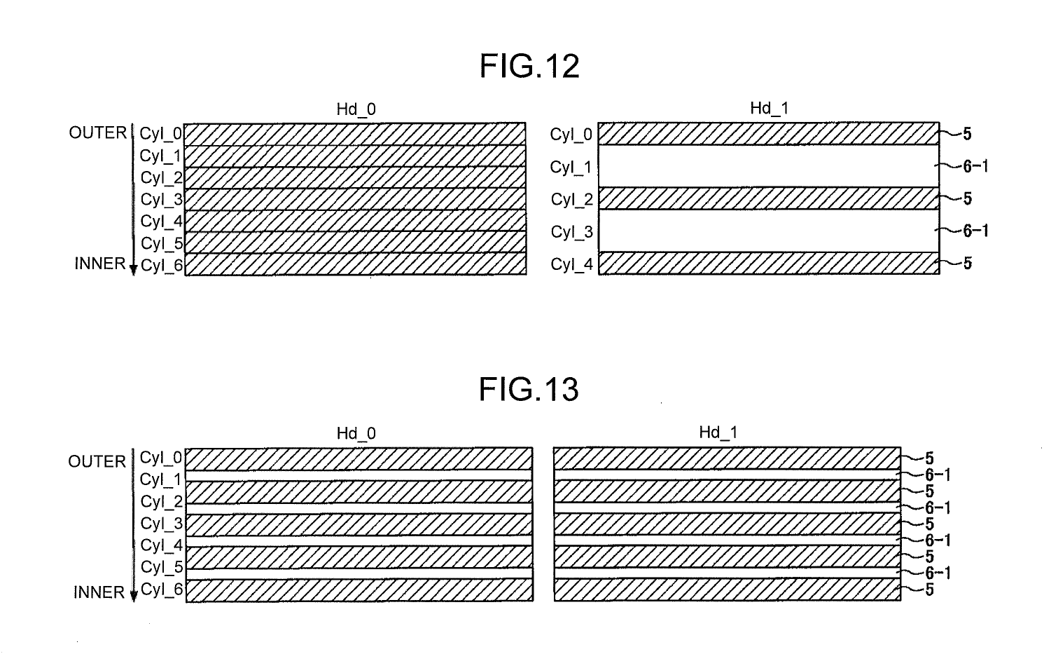

One example of the specific format by the skip processing with the expanded track pitch width of the track to be skipped comprises the following step (or procedure) ST51. FIG. 12 is a diagram for explaining the skip processing with the expanded track pitch width. In FIG. 12, the same portions as those in FIG. 9B are indicated by the same reference numerals and the explanation thereof is omitted.

In ST51, if it is previously known that the head width of the head Hd_1 is significantly larger than the designed value, the track pitch width of the head Hd_1 performing the skip processing of the third case is set to be two times that of the head Hd_0.

Besides, when the track pitch width of the track to be skipped can be varied, the track pitch width of the track to be skipped can be set to be narrower than the normal track pitch width. Accordingly, when it is unnecessary to secure the unused track 6-1 having the normal track pitch width, the track pitch width of the track to be skipped is set to be narrower than the normal track pitch width so as to apply the skip processing for the wide range.

One example of the specific format by the skip processing with variable track pitch width of the track to be skipped comprises the following step (or procedure) ST61. FIG. 13 is a diagram for explaining the skip processing by which the track pitch width of the track to be skipped is narrowed. In FIG. 13, the same portions as those in FIG. 9B are indicated by the same reference numerals and the explanation thereof is omitted.

In ST61, if it is previously known that the head widths of the heads Hd_0 and Hd_1 are almost equivalent to approximate designed values, the track pitch widths of the heads Hd_0 and Hd_1 performing the format in the third case are set to a value narrower than a head (not shown) that does not perform the skip processing.

As explained hereinbefore, in the embodiment, the sector is not assigned to the successive tracks at the time of executing the format unit command. Alternatively, the skip processing is dynamically and preferentially applied to a track (or a logical track) or a cylinder (or a logical cylinder) in a region including a track to be recorded that may influence an adjacent track (namely, a region expected to be influenced) according to the conditions or states of the storage device. Accordingly, the data destruction caused in the adjacent track due to the influence by the track to be recorded is easily prevented without taking extra time and causing extreme performance degradation of the storage device.

Next, the hardware structure and the processing procedures of the storage device are explained.

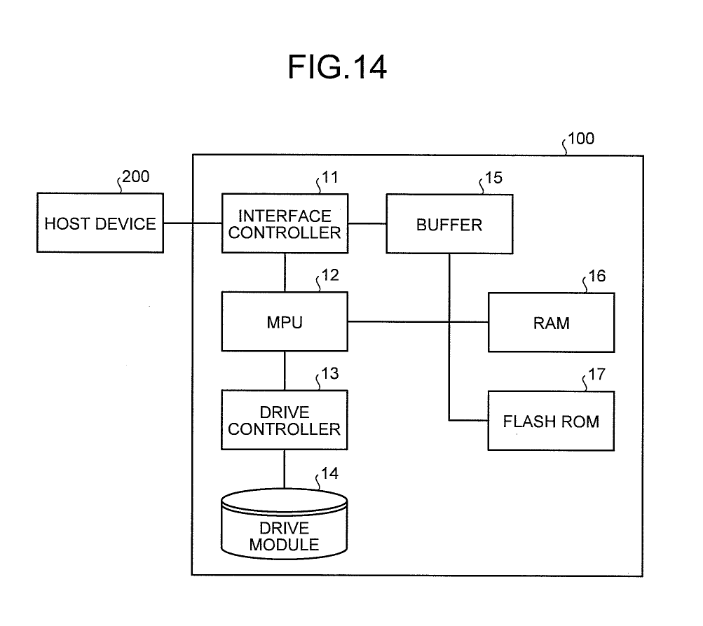

FIG. 14 is a block diagram of the storage device according to the embodiment. The magnetic storage device 100 comprises an interface controller 11, a micro processing unit (MPU) 12, a drive controller 13, a drive module 14, a buffer 15, a random access memory (RAM) 16, and a flash read only memory (ROM) 17, that are connected as illustrated in FIG. 14. The interface controller 11 controls exchange of data and command between a host device 200 and the magnetic storage device 100. The MPU 12 includes a controller that controls the whole magnetic storage device 100. The drive controller 13 controls the actuator unit 104 of the drive module 14 under the control of the MPU 12 to control the position of the head on the magnetic disk 103. The drive module 14 comprises various mechanisms such as the magnetic disk 103, the actuator 104, and the head as illustrated in FIG. 3. The buffer 15 temporarily stores therein each data and command that is exchanged between the host device 200 and the magnetic storage device 100. The RAM 16 stores therein each data such as an intermediate result of calculation processing performed by the MPU 12. The data stored in the RAM 16 comprises a skip track table that will be described later. The skip track table stores therein information for specifying the skip processing. The ROM 17 stores therein computer programs and data performed by the MPU 12.

Note that the hardware structure of the magnetic storage device 100 is not limited to the structure illustrated in FIG. 14, and it is needless to say that there are no particular restrictions on the structure as long as the skip processing can be preformed.

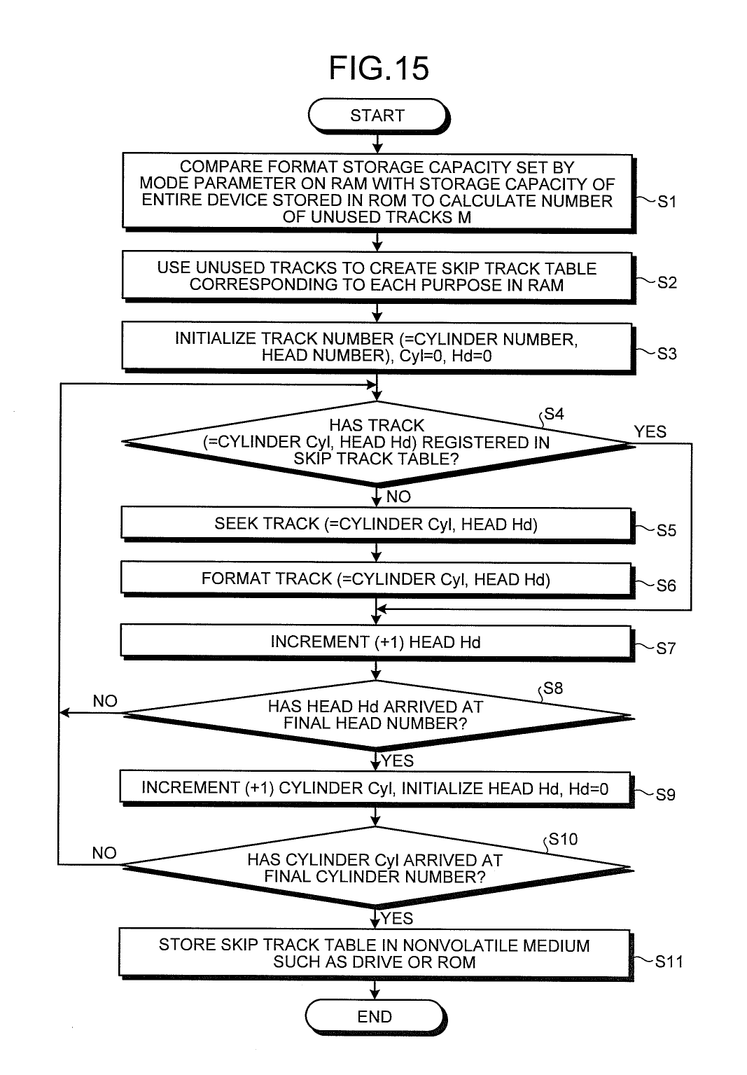

FIG. 15 is a flowchart for explaining the skip setting processing when the track pitch is fixed. The process illustrated in FIG. 15 is performed by the MPU 12 when the magnetic storage device 100 receives the format unit command from the host device 200. The host device 200 can issue the format unit command at any time after and before shipment of the magnetic storage device 100, for example. By performing the skip setting processing before the shipment of the magnetic storage device 100, the skip processing can be set as a default. On the other hand, by performing the skip processing after the shipment of the magnetic storage device 100, the skip processing can be set based on the temporal change and needs from a user. A mode parameter is previously stored in the RAM 16. The mode parameter comprises a format storage capacity indicating a storage capacity to be provided by the magnetic storage device 100. The storage capacity of the entire device indicates a storage capacity capable of being provided by the magnetic storage device 100 as a whole, and is previously stored in the ROM 17.

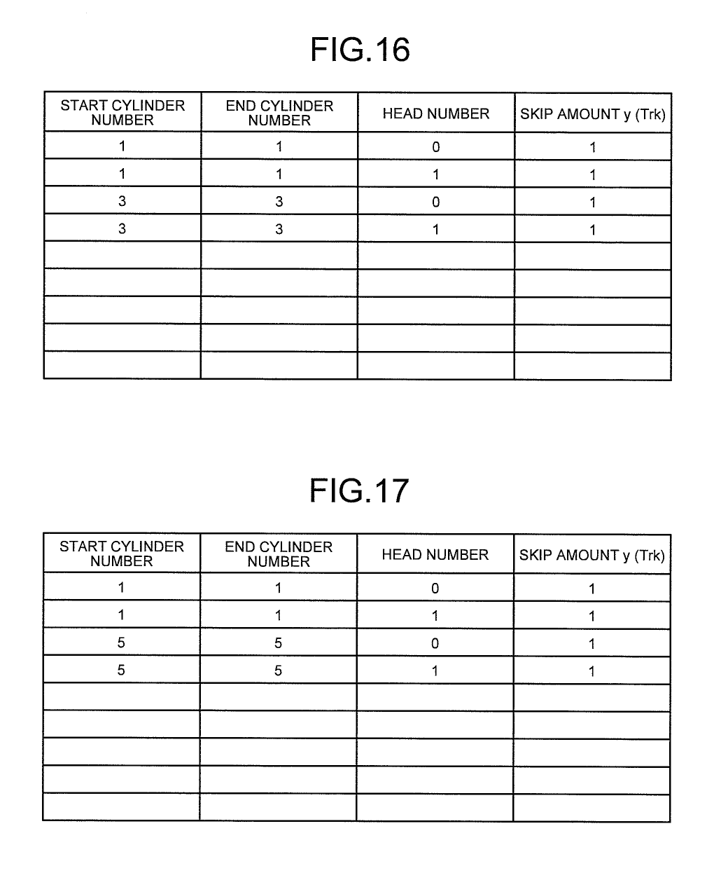

In FIG. 15, the number of unused tracks M is calculated by comparing the format storage capacity stored in the RAM 16 and the capacity of the entire device stored in the ROM 17 (S1). In S2, skip track tables corresponding to each purpose as illustrated in FIGS. 16 to 21 are created and stored in the RAM 16 so that the skip processing for skipping tracks (cylinders) is applied based on the number of unused tracks M, as many times as the format storage capacity can be secured. The skip track table comprises a start cylinder number, an end cylinder number, a head number, and a skip amount y (Trk).

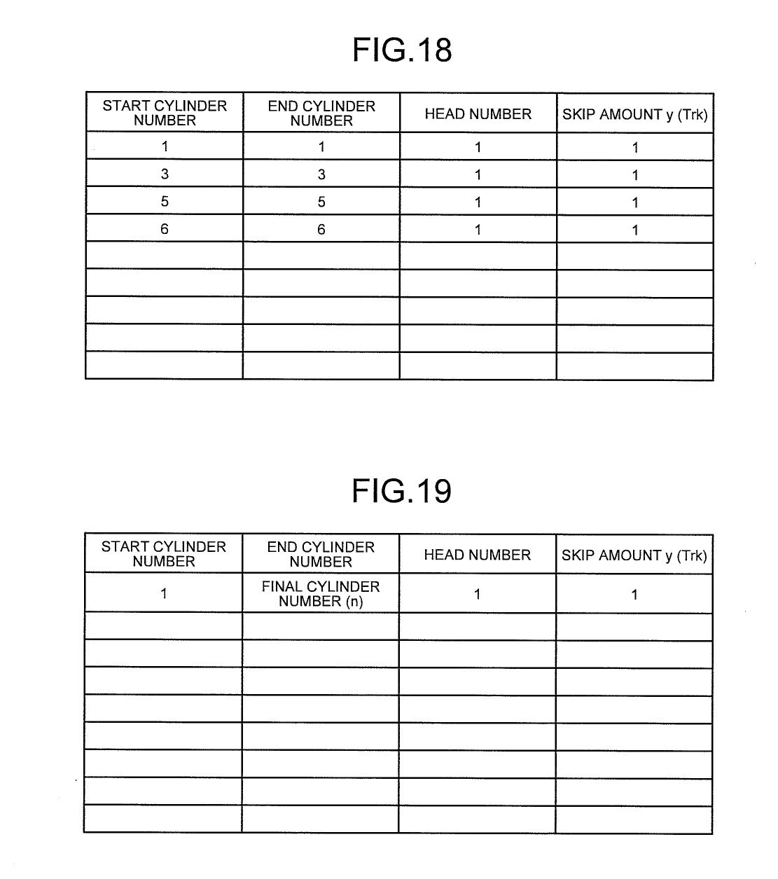

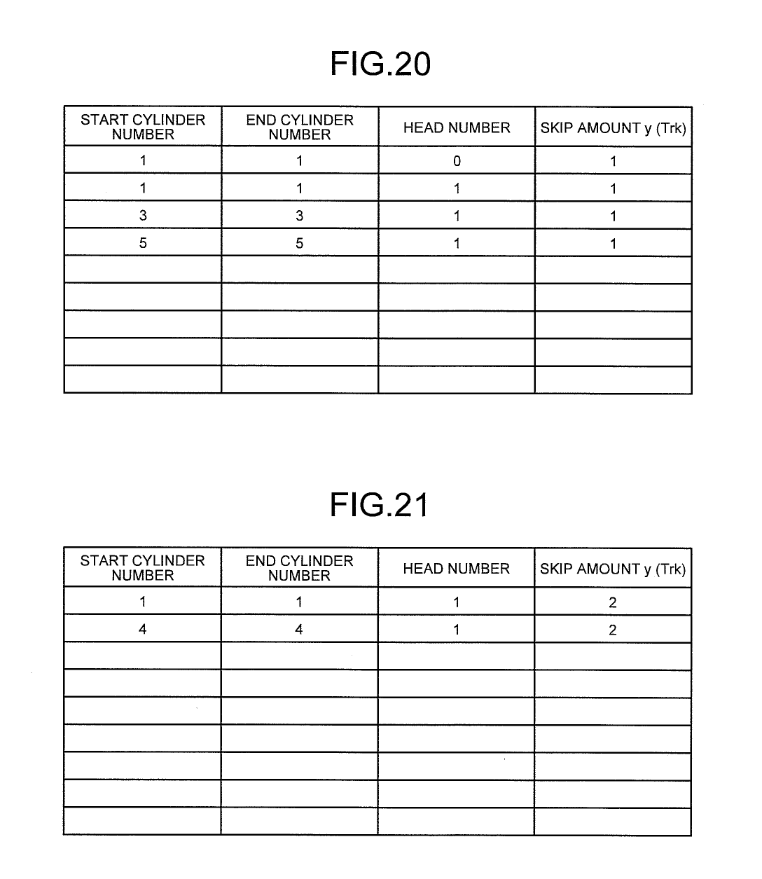

FIG. 16 is a diagram for explaining a skip track table for the first case, and FIG. 17 is a diagram for explaining a skip track table for the second case. FIG. 18 is a diagram for explaining a skip track table for the third case applied to only a specific region on the magnetic disk 103, and FIG. 19 is a diagram for explaining a skip track table for the third case applied to the whole region on the magnetic disk 103. FIG. 20 is a diagram for explaining a skip track table of when a skip excess amount of the head Hd_1 is applied to the head Hd_0 in the fourth case. In addition, FIG. 21 is a diagram for explaining a skip track table of when the skip amount of the head Hd_1 is expanded in the fifth case.

FIG. 16 is a skip track table corresponding to the format of FIG. 5B, and FIG. 17 is a skip track table corresponding to the format of FIG. 7B. FIG. 18 is a skip track table corresponding to the format of FIG. 9B, and FIG. 19 is a skip track table corresponding to the format of FIG. 8B. FIG. 20 is a skip track table corresponding to the format of FIG. 10, and FIG. 21 is a skip track table corresponding to the format of FIG. 11.

In S3, a cylinder number and a head number that determine a track number are initialized to Cyl=0 and Hd=0, respectively. In S4, it is determined whether the track, that is, the cylinder number Cyl and the head number Hd are registered in the skip track table. If the determination result is NO, the process proceeds to S5, and if the result is YES, the process proceeds to S7 described later. In S5, the track that is determined by the cylinder number Cyl and the head number Hd is sought. In S6, the track that is determined by the cylinder number Cyl and the head number Hd is formatted. In S7, the head number Hd is incremented by “1”, and the process proceeds to S8.

In S8, it is determined whether the head number Hd is a final head number. If the determination result is NO, the process returns to S4, and if the result is YES, the process proceeds to S9. In S9, the cylinder number Cyl is incremented by “1”, and the head number Hd is initialized to Hd=0. In S10, it is determined whether the cylinder number Cyl is the final cylinder number. If the determination result is NO, the process returns to S4, and if the result is YES, the process proceeds to S11. In S11, the skip track table is stored in a nonvolatile memory in the magnetic storage device 100, for example, the ROM 17, and the process is terminated.

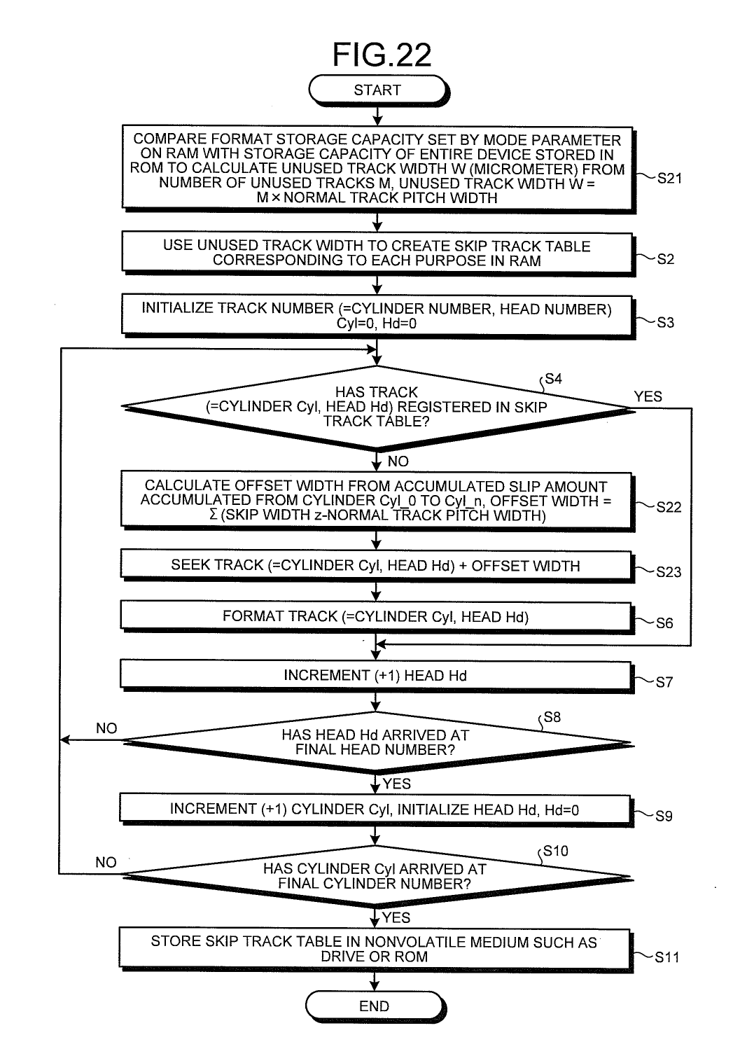

FIG. 22 is a flowchart for explaining the skip setting processing of when the track pitch is variable. The process illustrated in FIG. 22 is performed by the MPU 12 when the magnetic storage device 100 receives the format unit command from the host device 200. In FIG. 22, the same steps as those in FIG. 15 are indicated by the same reference numerals and the explanation thereof is omitted.

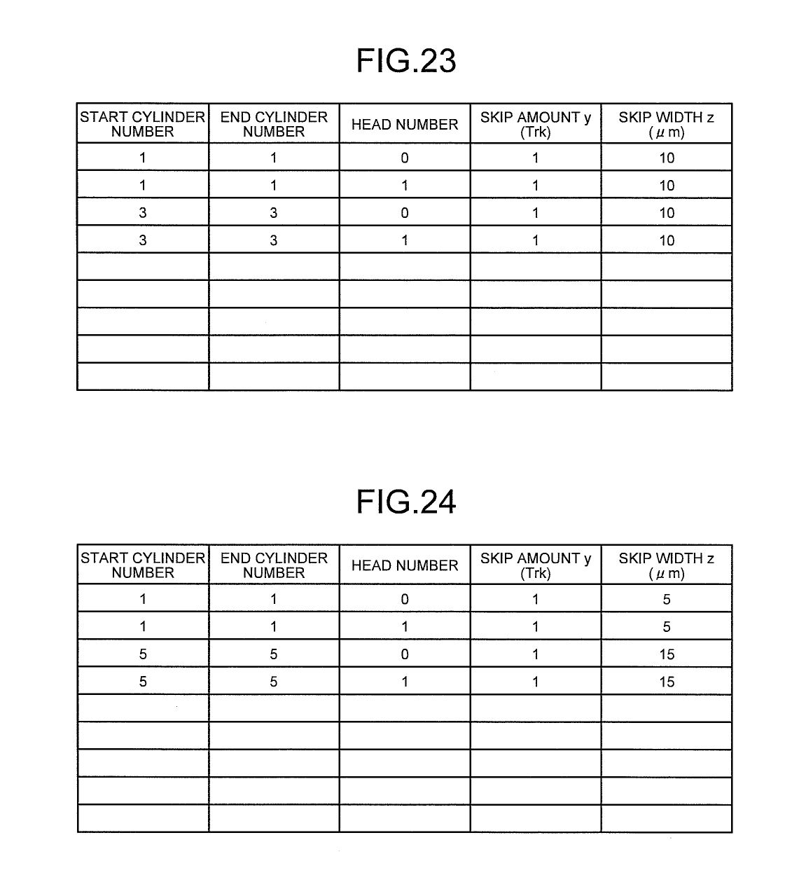

In FIG. 22, in S21, the format storage capacity stored in the RAM 16 is compared with the capacity of the entire device stored in the ROM 17 to calculate the number of unused tracks M and the width of unused tracks W (micrometer). The width of unused tracks W is calculated from W=M×(normal track pitch width). In S2, skip track tables corresponding to each purpose as illustrated in FIGS. 23 to 27 are created based on the number of unused tracks M, and stored in the RAM 16. The skip track table comprises a start cylinder number, an end cylinder number, a head number, a skip amount y (Trk), and a skip width z (micrometer).

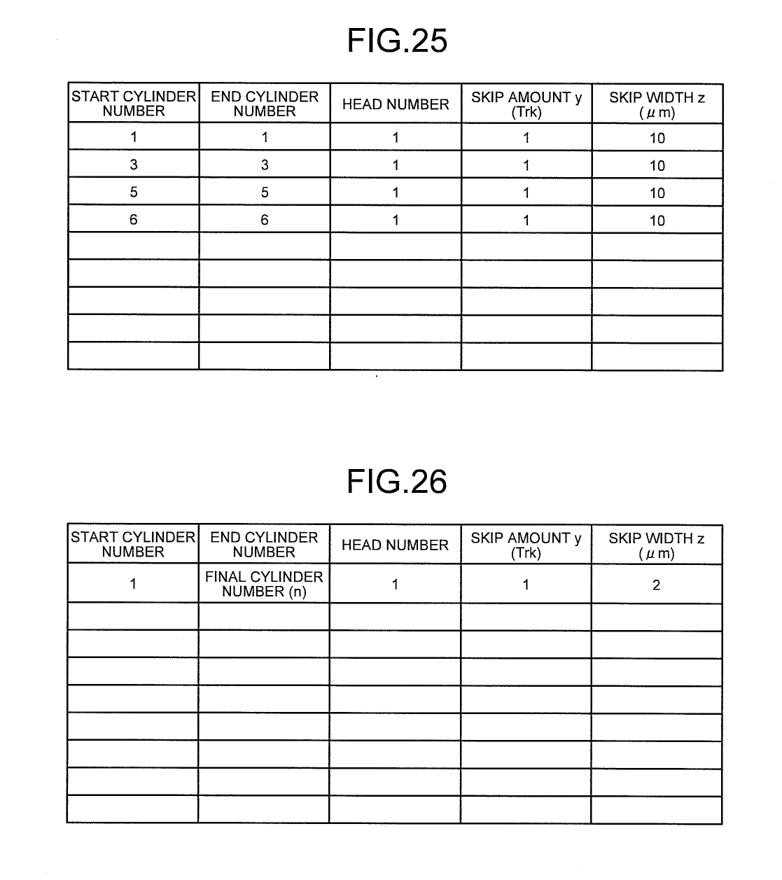

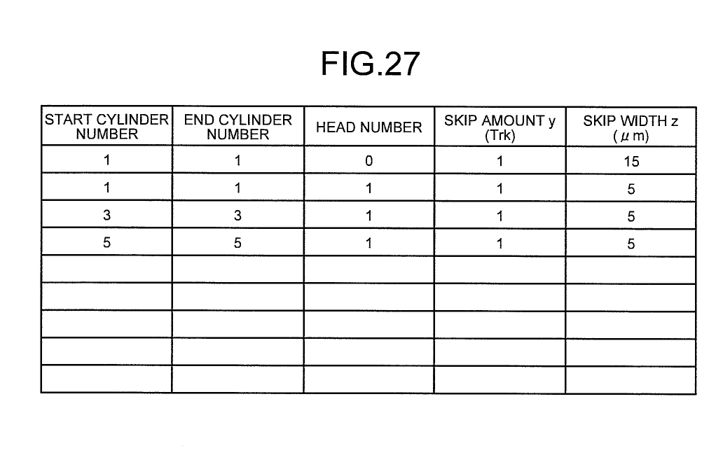

FIG. 23 is a diagram for explaining a skip track table for the first case, and FIG. 24 is a diagram for explaining a skip track table for the second case. FIG. 25 is a diagram for explaining a skip track table of when the third case is applied to a specific region on the magnetic disk 103, and FIG. 26 is a diagram for explaining a skip track table of when the third case is applied to the overall region on the magnetic disk 103. FIG. 27 is a diagram for explaining a skip track table when the skip excess amount of the head Hd_1 is applied to the head Hd_0 in the fourth case.

FIG. 23 is a skip track table of when the skip width z is set to 10 micrometers in the format of FIG. 5B, and FIG. 24 is a skip track table of when the skip width z is set to 5 micrometers and 15 micrometers in the format of FIG. 7B. FIG. 25 is a skip track table of when the skip width z is set to 10 micrometers in the format of FIG. 9B, and FIG. 26 is a skip track table of when the skip width z is set to 2 micrometers in the format of FIG. 8B. FIG. 27 is a skip track table of when the skip width z of the head Hd_0 is set to 15 micrometers and the skip width z of the head Hd_1 is set to 5 micrometers in the format of FIG. 10.

If the determination result is NO in S4, the process of S22 and S23 are performed, and then the process proceeds to S6. In S22, an offset width is calculated from an accumulated skip amount accumulated from the cylinder Cyl_0 to Cyl_n based on (an offset width)=Σ{(a skip width z)−(a normal track pitch width)}. In S23, the track that is determined by the cylinder number Cyl and the head number Hd is sought based on the calculated offset width.

When the magnetic storage device 100 in which the skip setting processing as illustrated in FIG. 15 or FIG. 22 has been performed is operating, because the skip processing is performed based on the skip track table by referring the skip track table stored in the nonvolatile memory in the magnetic storage device 100, for example, the ROM 17, high density recording with high reliability can be performed.

In the embodiment, the magnetic disk is explained as the magnetic recording medium. However, the shape of the magnetic recording medium is not limited to the disk shape.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording method comprising:
skipping a track by a skip amount in a skip region smaller than an overall recording region on a magnetic recording medium by using an extra region comprising a storage capacity of a storage device, the extra region being on the recording surface of the magnetic recording medium; and
recording data while skipping the track in the skip region, wherein
the skip region is a region comprising a track to be recorded on the magnetic recording medium which is predicted to influence an adjacent track in accordance with at least one of a condition and a state of the storage device.

2. The recording method of claim 1, wherein the magnetic recording medium is a magnetic disk, and the skip region is an outer region of the magnetic disk.

3. The recording method of claim 1, wherein the magnetic recording medium is a magnetic disk, and the skip region is an outer region and an inner region of the magnetic disk.

4. The recording method of claim 1, wherein the magnetic recording medium is a magnetic disk, and the skip region is a region comprising a Yaw angle of a head of the storage device with respect to the magnetic recording medium which is a predetermined value larger than zero.

5. The recording method of claim 1, wherein the skip region is a region scanned by one of a head with a width larger than a predetermined value, a head with magnetization characteristic stronger than the magnetization characteristic s of other heads, a head with magnetic flux leakage greater than magnetic flux leakages of the other heads, and a head with unstable on-track accuracy due to compatibility with the magnetic recording medium.

6. The recording method of claim 5, wherein the head is selected based on one of measurement information from a test of the storage device and logged information during actual operation.

7. The recording method of claim 1, wherein the skip amount is either fixed or variable which is a natural number multiple of a track width.

8. The recording method of claim 1, wherein the recording is performed based on a skip track table configured to store one of first information indicative of the skip region and second information comprising the first information and third information indicative of at least one of the skip amount and the selected head.

9. The recording method of claim 1, wherein a track pitch of the track skipped by the skipping is different from a track pitch of a track which is not skipped.

10. The recording method of claim 9, wherein the data recording is performed based on a skip track table configured to store one of first information indicative of the skip region and second information comprising the first information and third information indicative of at least one of the skip amount, the selected head, and a track pitch of the skipped track.

11. A storage device comprising:
a head configured to record data in a recording surface of a magnetic recording medium;
a driver configured to control a position of the head on the magnetic recording medium;
a storage module configured to store information indicative of skipping; and
a controller configured to control the driver to skip a track by a skip amount in a skip region smaller than an overall recording region on the magnetic recording medium based on the information in the storage module by using an extra region comprising a storage capacity of the storage device, and to control the head to record the data while skipping the track in the skip region, the extra region being on the recording surface of the magnetic recording medium, wherein
the skip region is a region comprising a track to be recorded on the magnetic recording medium which is predicted to influence an adjacent track in accordance with at least one of a condition and a state of the storage device.

12. The storage device of claim 11, wherein the magnetic recording medium is a magnetic disk, and the skip region is an outer region of the magnetic disk.

13. The storage device of claim 11, wherein the magnetic recording medium is a magnetic disk, and the skip region is an outer region and an inner region of the magnetic disk.

14. The storage device of claim 11, wherein the magnetic recording medium is a magnetic disk, and the skip region is a region comprising a Yaw angle of a head of the storage device with respect to the magnetic recording medium which is a predetermined value larger than zero.

15. The storage device of claim 11, wherein the skip region is a region scanned by one of a head with a width larger than a predetermined value, a head with magnetization characteristic stronger than the magnetization characteristic s of other heads, a head with magnetic flux leakage greater than magnetic flux leakages of the other heads, and a head with unstable on-track accuracy due to compatibility with the magnetic recording medium.

16. The storage device of claim 15, wherein the head is selected based on one of measurement information from a test of the storage device and logged information during actual operation.

17. The storage device of claim 11, wherein the skip amount is either fixed or variable which is a natural number multiple of a track width.

18. The storage device of claim 11, wherein
the storage module includes a skip track table configured to store one of first information indicative of the skip region and second information comprising the first information and third information indicative of at least one of the skip amount and the selected head, and
the controller is configured to control the driver to skip the track and to control the head to record the data, based on the one of the first information and the second information of the skip track table.

19. The storage device of claim 11, wherein a track pitch of the skipped track is different from a track pitch of other track that is not skipped.

20. The storage device of claim 19, wherein
the storage module comprises a skip track table configured to store one of first information indicative of the skip region and second information comprising the first information and third information indivative of at least one of the skip amount, the selected head, and a track pitch of the skipped track, and
the controller is configured to control the driver to skip the track and to control the head to record the data, based on the one of the first information and the second information of the skip track table.
